(19) United States
(12) Patent Application Publication
(10) Pub. No.: US 2021/0083526 A1
(43) Pub. Date: Mar. 18, 2021

(54) DEVICE AND METHOD FOR DETECTING A FOREIGN OBJECT IN A WIRELESS POWER TRANSFER SYSTEM

(71) Applicant: General Electric Company, Schenectady, NY (US)

(72) Inventors: Suma Memana Narayana Bhat, Bangalore (IN); Deepak Aravind, Bangalore (IN); Viswanathan Kanakasabai, Bangalore (IN); Pradeep Vijayan, Bangalore (IN); Adnan Kutubuddin Bohori, Bangalore (IN)

(21) Appl. No.: 17/048,415

(22) PCT Filed: Apr. 17, 2019
(86) PCT No.: PCT/US2019/027786

§ 371 Date: Oct. 16, 2020

(30) Foreign Application Priority Data
Apr. 19, 2018 (IN) 201841014947

(51) Int. Cl. H02J 50/60; H02J 50/10; H02J 50/40; H02J 50/80; H01F 38/14; B60L 53/124

(52) U.S. Cl. CPC H02J 50/60; H02J 50/10; H02J 50/40; B60K 6/28; H01F 38/14; B60L 53/124; H02J 2310/48; H02J 50/80

(57) ABSTRACT

A device for detecting a foreign object (112) in a WPT system is disclosed. The device includes an injection unit (122) to receive a DC power signal and generate a first AC power signal having a first frequency. Also, the device includes an array of coils (120) to receive the first AC power signal having the first frequency and generate a first electromagnetic field at the first frequency. Further, the device includes a detection unit (124) to measure a parameter of at least one of the DC power signal received by the injection unit (122) and the first AC power signal generated by the injection unit (122), and detect the foreign object (112) within the first electromagnetic field based on a change in the parameter of at least one of the DC power signal and the first AC power signal across at least one of the array of coils (120).

### BACKGROUND

Embodiments of the present invention relate generally to a wireless power transfer system and more particularly to a device and a method for detecting a foreign object in the wireless power transfer system.

An electric vehicle or a hybrid vehicle includes one or more batteries that supply electric power to drive the vehicle. For example, the batteries supply energy to an electric motor to drive a shaft in the vehicle, which in turn drives the vehicle. The batteries are used for supplying the power and hence may be drained and need to be charged from an external power source.

In general, power transfer systems are widely used to transfer power from a power source to one or more electric loads, such as for example, the batteries in the vehicle. Typically, the power transfer systems may be contact based power transfer systems or contactless power transfer systems. In the contact based power transfer systems, components, such as plug, socket connectors, and wires are physically coupled to the batteries for charging the batteries. However, due to environmental impact, such connectors and wires may be adversely affected. Also, high currents and voltages are used for charging the batteries. Hence, establishing a physical connection between the power source and the batteries in the vehicle may involve cumbersome safety measures. Also, such a power transfer system may become bulkier and heavier compared to the contactless power transfer system.

In the contactless power transfer systems, a charging device is used to convert an input electric power received from a power source to a transferrable electric power that is transmitted to charge one or more batteries in a receiver device, such as an electric vehicle. However, if a foreign object, such as a metal coin or metal can, is present in a power transmission path between the charging device and the receiver device, the transmitted electric power may be received by the foreign object. As a result, the foreign object may be substantially heated up and affect the components in the charging device. Also, there is an additional power loss in the system due to power consumption by the foreign object, which in-turn affects the efficiency of the power transfer system.

Accordingly, there is a need for an improved system and method for detecting foreign objects in a wireless power transfer system.

### BRIEF DESCRIPTION

In accordance with one embodiment of the present invention, a device for detecting a foreign object in a wireless power transfer system is disclosed. The device includes an injection unit configured to receive a direct current (DC) power signal and generate a first alternating current (AC) power signal having a first frequency based on the received DC power signal. Also, the device includes an array of coils operatively coupled to the injection unit and configured to receive the first AC power signal having the first frequency and generate a first electromagnetic field at the first frequency. Further, the device includes a detection unit operatively coupled to the array of coils and configured to measure a parameter of at least one of the DC power signal received by the injection unit and the first AC power signal generated by the injection unit, and detect the foreign object within the first electromagnetic field based on a change in the parameter of at least one of the DC power signal and the first AC power signal across at least one of the array of coils.

In accordance with another embodiment of the present invention, a method for detecting a foreign object in a wireless power transfer system is disclosed. The method includes receiving, by an injection unit, a direct current (DC) power signal. Also, the method includes generating, by the injection unit, a first AC power signal having a first frequency based on the DC power signal. Further, the method includes generating, by an array of coils operatively coupled to the injection unit, a first electromagnetic field at the first frequency. In addition, the method includes measuring, by a detection unit, a parameter of at least one of the DC power signal received by the injection unit and the first AC power signal generated by the injection unit. Furthermore, the method includes detecting, by the detection unit, the foreign object within the first electromagnetic field of the wireless power transfer system based on a change in the parameter of at least one of the DC power signal and the first AC power signal across at least one of the array of coils.

In accordance with yet another embodiment of the present invention, a wireless power transfer system is disclosed. The wireless power transfer system includes a foreign object detection sub-system including an injection unit configured to receive a direct current (DC) power signal and generate a first alternating current (AC) power signal having a first frequency based on the received DC power signal. Also, the foreign object detection sub-system includes an array of coils operatively coupled to the injection unit and configured to receive the first AC power signal having the first frequency and generate a first electromagnetic field at the first frequency. Furthermore, the foreign object detection sub-system includes a detection unit operatively coupled to the array of coils and configured to measure a parameter of at least one of the DC power signal received by the injection unit and the first AC power signal generated by the injection unit, and detect a foreign object within the first electromagnetic field of the wireless power transfer system based on a change in the parameter of at least one of the DC power signal and the first AC power signal across at least one of the array of coils. In addition, the wireless power transfer system includes a power transmission sub-system including a power drive unit configured to generate a second AC power signal having a second frequency, wherein power of the second AC power signal is greater than power of the first AC power signal. Also, the wireless power transfer system includes a primary coil operatively coupled to the power drive unit and configured to transmit the second AC power signal having the second frequency to a power reception sub-system, wherein the primary coil generates a second electromagnetic field at the second frequency. Furthermore, the wireless power transfer system includes a control unit operatively coupled to the power drive unit and configured to send a termination signal to the power drive unit in order to cease the transmission of the second AC power signal if the foreign object is detected.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic representation of a wireless power transfer system employed to charge a vehicle in accordance with aspects of the present invention;

FIG. 2 is a block diagram of a wireless power transfer system, in accordance with aspects of the present invention;

FIG. 3 is a block diagram of a foreign object detection (FOD) sub-system in accordance with aspects of the present invention;

FIGS. 4-6 illustrate schematic representations of electrical coupling between coils and an injection unit in accordance with aspects of the present invention;

FIG. 7 is a schematic representation of coils coupled to an injection unit through switches in accordance with aspects of the present invention;

FIGS. 8-9 illustrate graphical representations of parameters measured for detecting foreign objects in accordance with aspects of the present invention;

FIGS. 10-11 are schematic representations of a flexible mat employed of an FOD sub-system in accordance with aspects of the present invention;

FIG. 12 is a cross sectional view of a flexible mat in accordance with aspects of the present invention;

FIGS. 13-14 are schematic representations of a flexible mat positioned on a power transmission sub-system in accordance with aspects of the present invention; and

FIGS. 15-18 illustrate schematic representations of different arrangement of coils of an FOD sub-system in accordance with aspects of the present invention.

### DETAILED DESCRIPTION

As will be described in detail hereinafter, embodiments of a device and a method for detecting a foreign object in a wireless power transfer system are disclosed. In particular, embodiments of the device and the method discloses detection of the foreign object using low power signals and without affecting power transfer in the wireless power transfer system. Also, the device and the method ensures that the wireless power transfer system is compliant to society of automotive engineers (SAE) standards. Moreover, the foreign object is detected with good degree of sensitivity of detection.

Unless defined otherwise, technical and scientific terms used herein have the same meaning as is commonly understood by one of ordinary skill in the art to which this specification belongs. The terms “first”, “second”, and the like, as used herein do not denote any order, quantity, or importance, but rather are used to distinguish one element from another. The use of “including”, “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, terms “circuit” and “circuitry” and “controlling unit” may include either a single component or a plurality of components, which are either active and/or passive and are connected or otherwise coupled together to provide the described function. In addition, the term operationally coupled as used herein includes wired coupling, wireless coupling, electrical coupling, magnetic coupling, radio communication, software based communication, or combinations thereof.

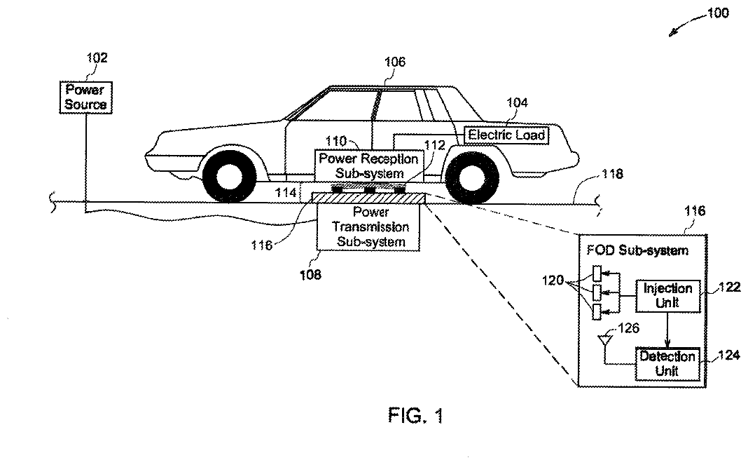

FIG. 1 is a schematic representation of a wireless power transfer system 100 employed to charge a vehicle 106 in accordance with aspects of the present invention. The vehicle 106 may be an electric vehicle or a hybrid vehicle. The wireless power transfer (WPT) system 100 is used to transmit electric power from a power source 102 to one or more electric loads 104 of the vehicle 106. The one or more electric loads 104 may include batteries. In one embodiment, the wireless power transfer system 100 may also be referred to as a contactless power transfer system.

The wireless power transfer (WPT) system 100 includes a power transmission sub-system 108 and a power reception sub-system 110. The power transmission sub-system 108 is configured to magnetically or wirelessly couple to the power reception sub-system 110 to transmit electric power from the power source 102 to the power reception sub-system 110. In one embodiment, the electric power may be in a range from about 100 W to about 22 kW. In one example, the electric power may be transmitted at a frequency that is in a range from about 80 kHz to about 90 kHz to comply with SAE standards. In one embodiment, the power transmission sub-system 108 may be a part of a charging station. It may be noted that the power transmission sub-system 108 may be positioned below a ground surface 118, as depicted in FIG. 1, or above the ground surface 118.

Further, the power reception sub-system 110 is configured to receive the electric power from the power transmission sub-system 108 and supply the received electric power to the one or more electric loads 104. In one embodiment, the power reception sub-system 110 may be positioned within the electric and/or hybrid vehicle 106. It may be noted that the power transmission sub-system 108 may be referred to as a wireless charging device and the power reception sub-system 110 may be referred to as a wireless receiver device.

If a foreign object 112, such as a metal coin or metal can, is present in a power transmission path 114 between the power transmission sub-system 108 and the power reception sub-system 110, the transmitted electric power may be received or consumed by the foreign object 112. Further, if the foreign object 112 remains undetected in the power transmission path 114, the foreign object 112 may be substantially heated up and can affect the components in the power transmission sub-system 108. Also, as the foreign object 112 is heated up, temperature in the system may increase above 80 degrees Celsius which is beyond the limit specified according to the SAE standards. In certain embodiments, the presence of the foreign object 112, such as the coin or the can may not appreciably affect the power transmitted by the power transmission sub-system 108. Hence, it would be difficult to detect the foreign object 112 based on the power transmitted by the power transmission sub-system 108.

To overcome the above problems/drawbacks, the exemplary wireless power transfer system 100 includes a foreign object detection (FOD) sub-system 116 that is configured to detect the foreign object 112 within the wireless power transfer system 100. The foreign object 112 may be referred to as an electric current conducting object or magnetically permeable object that intercepts or varies electromagnetic field of the wireless power transfer system 100. In one example, the foreign object 112 includes a metal coin, a metal can, metal nail, foil, metal plate, and ferrite.

In one embodiment, the FOD sub-system 116 may be a flexible mat that is placed on the power transmission sub-system 108. In one example, the flexible mat 116 may include thermally conductive and electrically insulating material that aids in conforming to a shape corresponding to a position of the power transmission sub-system 108 on the ground surface 118. Further, the FOD sub-system 116 includes an array of coils 120, an injection unit 122, and a detection unit 124. The injection unit 122 is operatively coupled to the array of coils 120 and the detection unit 124. Further, a first transceiver 126 is operatively coupled to the detection unit 124.

The injection unit 122 is configured to receive a direct current (DC) power signal and generate a first alternating current (AC) power signal having a first frequency based on the received DC power signal. In one embodiment, the injection unit 122 may include an internal power source, such as a battery that provides the DC power signal. In another embodiment, the injection unit 122 may receive the DC power signal from the external power source 102. The DC power signal may be representative of electric power that is in a range from about 5 V to about 20 V.

Further, the injection unit 122 includes one or more converters that are configured to operate at a determined switching frequency to convert the DC power signal to the first AC power signal having the first frequency. In one example, the first frequency may be in a range from about 150 kHz to about 10 MHz. In another example, the first frequency may be in a range from about 10 kHz to about 75 kHz. Also, the first AC power signal is in a range from about 5 V to about 20 V. In one embodiment, the injection unit 122 may include a bridge circuit and a local controller that provides control pulses to the bridge circuit to convert the DC power signal to the first AC power signal having the first frequency. In another embodiment, the injection unit 122 may include a digital circuit or a processor that performs one or more functions based on pre-stored instructions or programs to convert the DC power signal to the first AC power signal having the first frequency. The injection unit 122 is further configured to transmit the first AC power signal having the first frequency to the array of coils 120.

Furthermore, the array of coils 120 is configured to receive the first AC power signal having the first frequency and generate a first electromagnetic field at the first frequency. In particular, the array of coils 120 may be tuned to excite at the first frequency to generate the first electromagnetic field at the first frequency. It may be noted that the array of coils 120 may be activated concurrently or sequentially to generate the first electromagnetic field. Also, the array of coils 120 may be arranged in one or more predetermined patterns to improve sensitivity of detection of the foreign object 112. It may be noted that each of the array of coils 120 may be compact and wound within a thin gauge wire.

Furthermore, the detection unit 124 is configured to measure a parameter of the DC power signal received by the injection unit 122 and the parameter of the first AC power signal generated by the injection unit 122. In one example, the parameter of the DC power signal may be power, current, or voltage of the DC power signal. In another example, the parameter of the AC power signal may be power, current, voltage, or a phase angle between the current and the voltage of the first AC power signal. In one embodiment, if the power transmission sub-system 108 is transmitting power at 85 kHz, the array of coils 120 in the FOD sub-system 116 may transmit power at 500 kHz to avoid interference with the power transmitted by the power transmission sub-system 108. Also, power of the first AC power signal is less than power transmitted by the power transmission sub-system 108. In one example, power of 10 W is sufficient for the FOD sub-system 116 to detect or scan the foreign object 112.

Further, the detection unit 124 is configured to detect the foreign object 112 based on a change in the parameter of the DC power signal and/or the first AC power signal across at least one of the array of coils 120. In one embodiment, the array of coils 120 may generate the first electromagnetic field corresponding to the first AC power signal. If the foreign object 112 is present within the first electromagnetic field, the array of coils 120 consumes more power of the first AC power signal. As a result, the parameter, such as the power of the first AC power signal and the power of the DC power signal varies from a predefined value or a baseline value. The predefined value may be referred to a value of the parameter that is determined in the absence of the foreign object 112 within the first electromagnetic field.

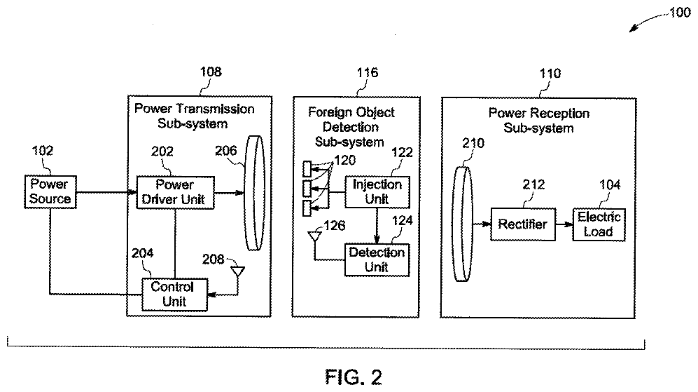

The detection unit 124 detects the change in the power of the first AC power signal or the change in the power of the DC power signal. Further, if the change in the power of the first AC power signal or the change in the power of the DC power signal is greater than a threshold value, the detection unit 124 detects the presence of the foreign object 112 between the power transmission sub-system 108 and the power reception sub-system 110. In one example, if the power of the first AC power signal is 5% greater than the predefined value, the detection unit 124 detects the presence of the foreign object 112. It may be noted that the detection unit 124 may also be used to detect other parameters, such as the current and the voltage, and is not limited to the power of the DC power signal and/or the first AC power signal. The aspect of detecting the foreign object 112 is explained in greater detail with reference to FIG. 2. Furthermore, upon detecting the foreign object 112, the detection unit 124 transmits a control signal to the power transmission sub-system 108 via the first transceiver 126 to cease the transmission of the electric power from the power transmission sub-system 108 to the power reception sub-system 110. In one embodiment, the control signal can be transmitted using a wired connection between the detection unit 124 and the power transmission sub-system 108. By ceasing the transmission of the electric power from the power transmission sub-system 108, overheating of the foreign object 112 may be avoided, thereby preventing any adverse effect on the components in the system 100. Also, the power consumption of the foreign object is substantially reduced, which in turn, reduces power loss and improves the efficiency of the system 100. The aspect of detecting the foreign object 112 will be explained in greater detail with reference to FIG. 2.

Referring to FIG. 2, a block diagram of the wireless power transfer (WPT) system 100 in accordance with aspects of the present invention is shown. The wireless power transfer system 100 includes the power transmission sub-system 108, the power reception sub-system 110, and the foreign object detection (FOD) sub-system 116.

In the illustrated embodiment, the power transmission sub-system 108 includes a power drive unit 202, a control unit 204, a primary coil 206, and a second transceiver 208 coupled to the control unit 204. The power drive unit 202 is electrically coupled to the power source 102 and the control unit 204. The power source 102 is configured to supply a direct current (DC) power signal to the power drive unit 202. In some embodiments, electric power of the DC power signal may be in a range from about 100 W to about 22 kW. In one embodiment, the power source 102 may be a part of the wireless power transfer system 100. In another embodiment, the power source 102 may be positioned external to the wireless power transfer system 100.

The power drive unit 202 is configured to receive the direct current (DC) power signal from the power source 102. Further, the power drive unit 202 is configured to operate at a determined switching frequency to convert the direct current (DC) power signal to a second alternating current (AC) power signal having a second frequency. Particularly, the control unit 204 may determine the switching frequency of the power drive unit 202 based on the electric load 104. In one embodiment, the control unit 204 may include a digital circuit or a processor that performs one or more functions based on pre-stored instructions or programs. In one example, the second AC power signal is representative of power that is in a range from about 100 W to about 22 kW. Also, the second frequency may be in a range from about 80 kHz to about 90 kHz as per SAE standard. The power drive unit 202 is further configured to transmit the second AC power signal having the second frequency to the primary coil 206. Furthermore, the primary coil 206 is used to wirelessly transmit the second AC power signal having the second frequency from the power drive unit 202 to the power reception sub-system 110.

Further, the power reception sub-system 110 includes a secondary coil 210, a rectifier 212, and the load 104. The secondary coil 210 is magnetically coupled to the primary coil 206 and configured to receive the second AC power signal having the second frequency from the primary coil 206. More specifically, when the primary coil 206 receives the second AC power signal having the second frequency, the primary coil 206 generates a second electromagnetic field at the second frequency. The second electromagnetic field is intercepted by the secondary coil 210 in the power reception sub-system 110. As result, voltage corresponding to the second AC power signal is induced in the secondary coil 210 and is received by the rectifier 212 in the power reception sub-system 110. The rectifier 212 is configured to convert the second AC power signal having the second frequency to an output power having a DC voltage. Further, the rectifier 212 is configured to transmit the output power having the DC voltage to the electric load 104. In one example, the output power may be used for charging the electric load 104 including one or more batteries positioned in the vehicle 106.

During operation of the wireless power transfer system 100, the power drive unit 202 drives the primary coil 206 to transmit the second AC power signal having the second frequency to the power reception sub-system 110. In particular, the primary coil 206 generates the second electromagnetic field that is corresponding to the second AC power signal at the second frequency. The injection unit 122 of the FOD sub-system 116 receives the DC power signal and converts the DC power signal to the first AC power signal having the first frequency while the primary coil 206 is transmitting the second AC power signal having the second frequency. The DC power signal may be received from an internal source, such as a battery, or from an external source, such as the power source 102. Further, the injection unit 122 drives the array of coils 120 to generate the first electromagnetic field corresponding to the first AC power signal. In particular, each of the array of coils 120 generates the first electromagnetic field that is corresponding to the first AC power signal having the first frequency. In another embodiment, only a subset of the array of coils 120 generates the first electromagnetic filed that corresponds to the first AC power signal having the first frequency.

The detection unit 124 measures a parameter of the DC power signal received by the injection unit 122 and/or the parameter of the first AC power signal generated by the injection unit 122 upon generating the first electromagnetic field. In one example, the parameter of the DC power signal includes current, voltage, or power of the DC power signal. In another example, the parameter of the first AC power signal includes current, voltage, power, or a phase angle between the voltage and the current of the first AC power signal.

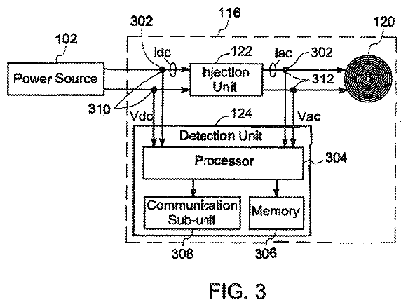

FIG. 3 is a block diagram of the foreign object detection (FOD) sub-system 116 in accordance with aspects of the present invention. The detection unit 124 includes a sensing sub-unit 302, a processor 304, a memory 306, and a communication sub-unit 308. The sensing sub-unit 302 includes one or more first sensors 310 coupled to an input terminal of the injection unit 122 to measure the parameter of the DC power signal received by the injection unit 122. In a similar manner, the sensing sub-unit 302 includes one or more second sensors 312 coupled to an output terminal of the injection unit 122 to measure the parameter of the first AC power signal generated by the injection unit 122.

Further, the processor 304 is coupled to the sensing sub-unit 302 to receive the measured parameters from the first sensors 310 and the second sensors 312. Also, the processor 304 is configured to compare the measured parameter to a predefined value to determine the change in the parameter of at least one of the DC power signal and the first AC power signal. The predefined value may be referred to a value of the parameter that is determined in the absence of the foreign object 112 (shown in FIG. 1) within the first electromagnetic field. In one example, the processor 304 may compare the power of the first AC power signal with a predefined power value. In another example, the processor 304 may compare the current of the DC power signal with a corresponding predefined current value.

Thereafter, the processor 304 detects the foreign object 112 based on a change in the parameter of at least one of the DC power signal and the first AC power signal across at least one of the array of coils 120. In particular, the detection unit 124 detects the foreign object 112 if the change in the parameter of at least one of the DC power signal and the first AC power signal is greater than a threshold value. For example, if the power of the first AC power signal is 5% greater than the predefined power value, the detection unit 124 detects the presence of the foreign object 112 within the first electromagnetic field. Similarly, if the current of the DC power signal is 5% greater than the predefined current value, the detection unit 124 detects the presence of the foreign object 112 within the first electromagnetic field.

The processor 304 generates a control signal to indicate the presence of the foreign object 112 upon detecting the foreign object 112. Also, the processor 304 transmits the control signal to the communication sub-unit 308 which in turn transmits the control signal to the power transmission sub-system 108 via the first transceiver 126 (shown in FIG. 2).

Referring again to FIG. 2, the control unit 204 of the power transmission sub-system 108 receives the control signal via the second transceiver 208 that is communicatively coupled to the first transceiver 126. Further, the control unit 204 ceases the transmission of the second AC power signal from the primary coil 206. In one example, the control unit 204 may cease transmitting the pulse width modulated signals or switching pulses to the power drive unit 202, which in turn prevents the power drive unit 202 from transmitting the second AC power signal. In another example, the control unit 204 may turn-off the power source 102 to completely deactivate the power transmission sub-system 108. In yet another example, the primary coil 206 may comprise of an array of coils, and the control unit 204 may alternatively activate a subset of the array of coils, such that the array of coils near the foreign object 112 are not excited.

Thus, by employing the exemplary FOD sub-system 116, the foreign object 112 located between the power transmission sub-system 108 and the power reception sub-system 110 is detected.

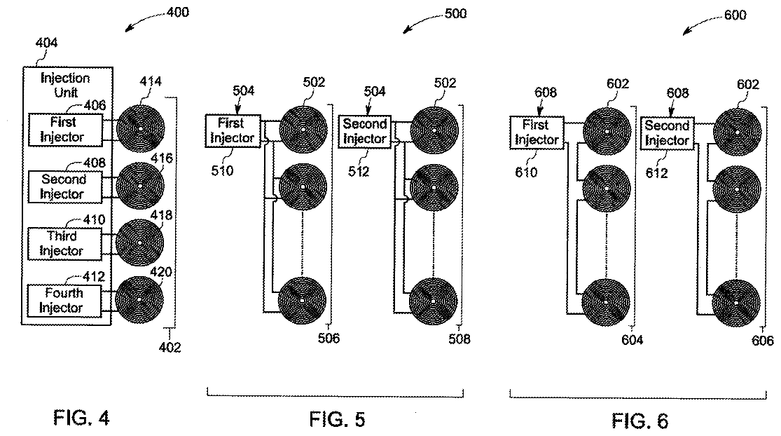

Referring to FIG. 4, a schematic representation of an array of coils 402 and an injection unit 404 employed in an FOD sub-system 400 in accordance with an embodiment of the present invention is depicted. The array of coils 402 is similar to the array of coils 120 of FIG. 1. Similarly, the injection unit 404 is similar to the injection unit 122 of FIG. 1. In the illustrated embodiment, each coil of the array of coils 402 is provided with a dedicated injection circuit to drive the corresponding coil to generate the first electromagnetic field. In particular, the injection unit 404 includes a first injector 406, a second injector 408, a third injector 410, and a fourth injector 412. It may be noted that the injection unit 404 may include any number of injectors, and is not limited to the number of injectors shown in FIG. 4. Further, each coil of the array of coils 402 is individually coupled to a corresponding injector of the injection unit 404. For example, the first coil 414 is coupled to the first injector 406, the second coil 416 is coupled to the second injector 408, the third coil 418 is coupled to the third injector 410, and the fourth coil 420 is coupled to the fourth injector 412. Further, each of the injectors 406, 408, 410, 412 may independently drive the corresponding coil of the arrays of coils 402 to generate the first electromagnetic field. The injectors 406-412 may be operated in a continuous injection mode or an intermittent mode. In the continuous injection mode, the coils 402 are continuously driven by the injectors 406-412 resulting in high power consumption, which in-turn aids in fast detection of the foreign object. In the intermittent injection mode, the coils 402 are intermittently driven by the injectors 406-412 resulting in low power consumption, which in-turn aids in slow detection of the foreign object.

FIG. 5 is a schematic representation of an array of coils 502 and an injection unit 504 employed in an FOD sub-system 500 in accordance with another embodiment of the present invention. The array of coils 502 is similar to the array of coils 120 of FIG. 1. Similarly, the injection unit 504 is similar to the injection unit 122 of FIG. 1. In this embodiment, the array of coils 502 includes a first set of coils 506 and a second set of coils 508. The first set of coils 506 are coupled in parallel to each other and electrically coupled to a first injector 510 of the injection unit 504. Also, the first injector 510 concurrently drives the first set of coils 506 to generate the first electromagnetic field. Similarly, the second set of coils 508 are coupled in parallel to each other and electrically coupled to a second injector 512 of the injection unit 504. Also, the second injector 512 concurrently drives the second set of coils 508 to generate the first electromagnetic field. It may be noted that the array of coils 502 may include any number of sets of coils, and is not limited to the first set of coils 506 and the second set of coils 508 as depicted in FIG. 5.

FIG. 6 is a schematic representation of an array of coils 602 and an injection unit 608 employed in an FOD sub-system 600 in accordance with yet another embodiment of the present invention. The array of coils 602 is similar to the array of coils 120 of FIG. 1. Similarly, the injection unit 608 is similar to the injection unit 122 of FIG. 1. In this embodiment, the array of coils 602 includes a first set of coils 604 and a second set of coils 606. The first set of coils 604 are coupled in series to each other and electrically coupled to a first injector 610 of the injection unit 608. Also, the first injector 610 drives the first set of coils 604 to generate the first electromagnetic field. Similarly, the second set of coils 606 are coupled in series to each other and electrically coupled to a second injector 612 of the injection unit 608. Also, the second injector 612 drives the second set of coils 606 to generate the first electromagnetic field. In one embodiment, the first set of coils 604 and the second set of coils 606 may be sequentially or concurrently driven by the respective injectors 610, 612. It may be noted that the array of coils 602 may include any number of sets of coils, and is not limited to the first set of coils 604 and the second set of coils 606, as depicted in FIG. 6.

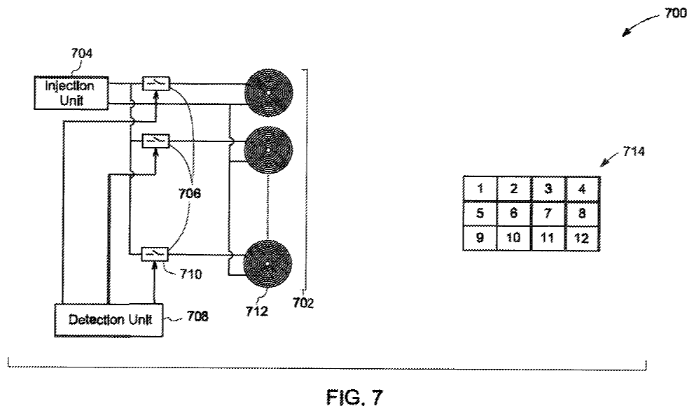

Referring to FIG. 7, a schematic representation of an array of coils 702 and an injection unit 704 employed in an FOD sub-system 700 in accordance with one embodiment of the present invention is depicted. The array of coils 702 is similar to the array of coils 120 of FIG. 1. Similarly, the injection unit 704 is similar to the injection unit 122 of FIG. 1. Further, the detection unit 708 is similar to the detection unit 124 of FIG. 1. The FOD sub-system 700 includes one or more switches 706 that are coupled to the injection unit 704 and the array of coils 702. Also, each of the switches 706 is coupled to the injection unit 704 and a corresponding coil of the array of coils 702. Further, the detection unit 708 is electrically coupled to these switches 706 and configured to activate each of the switches 706 to transmit the first AC power signal from the injection unit 704 to the corresponding coil of the array of coils 702.

Also, the detection unit 708 is configured to select and drive one or more coils of the array of coils 702 for transmitting the first AC power signal by activating a corresponding switch of the plurality of switches 706. The one or more coils 702 are selected and driven to concurrently generate the first electromagnetic field corresponding to the first AC power signal. In particular, the processor 304 (shown in FIG. 3) of the detection unit 708 transmits switching pulses to activate or deactivate the switches 706. If the switch 710 is activated, the corresponding coil 712 is electrically coupled to the injection unit 704 to receive the first AC power signal. If the switch 710 is deactivated, the corresponding coil 712 is electrically decoupled from the injection unit 704.

Further, the detection unit 708 may activate the switches 706 in a predefined order to minimize mutual interference between the coils 702. For example, as depicted in table 714, the detection unit 708 may activate switches 706 corresponding to the coils numbered 1, 5, 9 for a first time-period. Further, the detection unit 708 may activate switches 706 corresponding to the coils numbered 2, 6, 10 for a second time-period. Also, the detection unit 708 may activate switches 706 corresponding to the coils numbered 3, 7, 11 for a third time-period. Similarly, the detection unit 708 may activate switches 706 corresponding to the coils numbered 4, 8, 12 for a fourth time-period. Further, the detection unit 708 may repeat such an order of activating the switches 706 for detecting the foreign object. It may be noted that the detection unit 708 may use any predefined order to activate the switches 706 and cyclically switch between the coils to detect or scan for the foreign object. In on example, the switches 706 are activated in the predefined order to select and drive a corresponding coil of the array of coils in a cyclic manner.

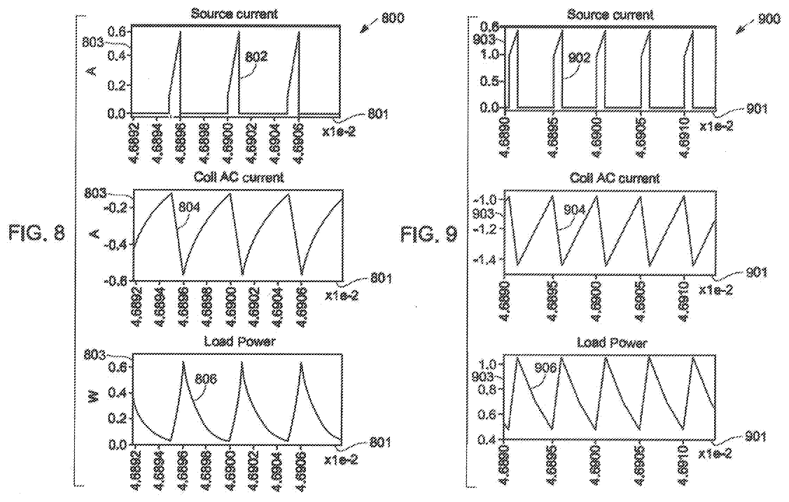

FIG. 8 is a graphical representation 800 of parameters measured by the detection unit in the absence of the foreign object in accordance with aspects of the present invention. The parameters are plotted considering time along x-axis 801 and magnitude along y-axis 803. A curve 802 represents variation of the electric current of the DC power signal received by the injection unit. A curve 804 represents variation of the electric current of the first AC power signal transmitted by the injection unit. Similarly, the curve 806 represents variation of the power of the first AC power signal transmitted by the injection unit.

FIG. 9 is a graphical representation 900 of parameters measured by the detection unit in the presence of the foreign object, in accordance with aspects of the present invention. The parameters are plotted considering time along x-axis 901 and magnitude along y-axis 903. A curve 902 represents variation of the electric current of the DC power signal received by the injection unit. A curve 904 represents variation of the electric current of the first AC power signal transmitted by the injection unit. Similarly, a curve 906 represents variation of the power of the first AC power signal transmitted by the injection unit. It is evident that the parameter, such as the current and the power changes when the foreign object is present within the system. Such a change in the parameter is monitored by the detection unit to detect the foreign object.

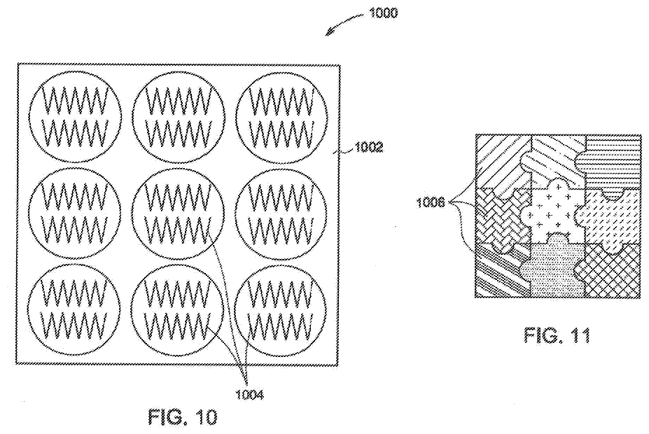

FIGS. 10 and 11 shows a schematic representation of the FOD sub-system 116 having a mat 1000 in accordance with one embodiment of the present invention. In one embodiment, the mat 1000 may be a stand-alone structure detachably coupled to the power transmission sub-system (shown in FIG. 1). In one example, the mat 1000 may be used as a plug-and-play structure with the wireless power transfer system. The mat 1000 may include a flexible material, a hard material, or a combination thereof. For ease of understanding, the mat 1000 is referred as a flexible mat. The flexible mat 1000 includes a thermally conductive and electrically insulating (TCEI) material that forms an enclosure 1002 for the array of coils 1004 and the electronics such as the injection unit and the detection unit. In one embodiment, the thermally conductive and electrically insulating (TCEI) material may include elastomers or thermoplastics with fillers that are wear resistant. In one embodiment, the elastomers may be silicone rubber. The fillers may be TCEI fillers such as aluminum oxide, aluminum nitride, beryllium oxide, boron nitride, graphene oxide, silicon carbide, and silicon nitride. Similarly, the thermoplastics may be polyolefins, polycarbonate, poly (methyl-methacrylate) (PMMA), and polyesters. Also, the enclosure 1002 may be foldable along with the array of coils 1004. In one embodiment, the mat 1000 may be integrated with any type of standard SAE transmitter system. In one embodiment, the flexible mat 1000 may have a length that is in a range from about 0.5 m to about 2.2 m, a width that is in a range from about 0.5 m to about 2.2 m. Also, the flexible mat 1000 may have a thickness that is in a range from about 1 mm to about 20 mm. In one embodiment, the flexible mat 1000 may be a unitary structure. In another embodiment, the flexible mat 1000 may be formed by integrating smaller mat structures 1006 as depicted in FIG. 11. Such mat structures 1006 may have a predefined design such as jigsaw design to aid in integration with each other. The size of the flexible mat 1000 may be varied to any desired size due to the use of smaller mat structures. It may be noted that each these coils 1004 may be compact and wound within a thin gauge wire. The coils 1004 can also be printed on flexible or regular printed circuit board. Also, the coils 1004 detects any change in the transmitted power compared to a large primary coil of the power transmission sub-system since the power consumption of the coils 1004 are low.

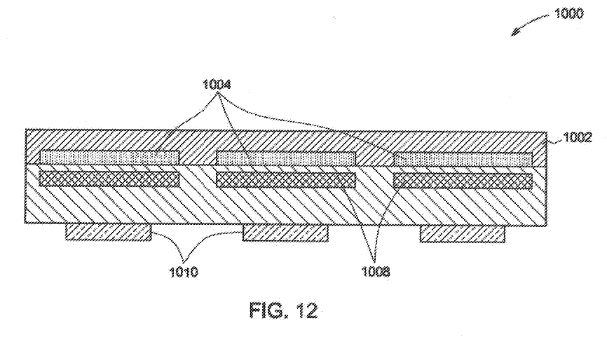

FIG. 12 is a cross sectional view of the flexible mat 1000 of the FOD sub-system in accordance with an embodiment of the present invention. Reference numeral 1002 represents the enclosure of the flexible mat 1000. Reference numeral 1004 represents the array of coils that are printed on a PCB board 1008. In one embodiment, the array of coils 1004 may include wound coils that are placed towards a top surface of the enclosure 1002 without using the PCB board 1008. Reference numeral 1010 represents electronics such as the injection unit and the detection unit that are positioned at a location where the first and second electromagnetic fields are minimum.

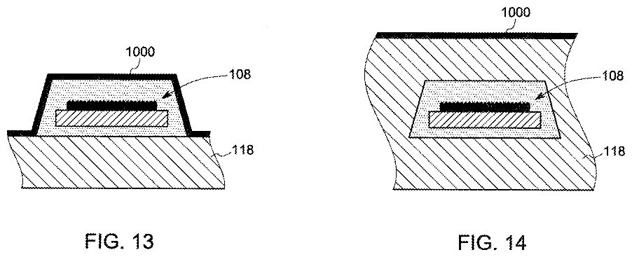

FIGS. 13-14 are schematic representations of the flexible mat 1000 positioned on the power transmission sub-system 108, in accordance with an embodiment of the present invention. With reference to FIG. 13, the power transmission sub-system 108 is position above the ground surface 118. Also, the flexible mat 1000 conforms to the shape of the power transmission sub-system 108 covering an entire surface area of the power transmission sub-system 108 and a portion of the ground surface 118 adjacent to the power transmission sub-system 108. With reference to FIG. 14, the power transmission sub-system 108 is positioned below the ground surface 118. Also, the flexible mat 1000 is placed on the ground surface 118 covering at least a portion of the ground surface 118 that is above the power transmission sub-system 108.

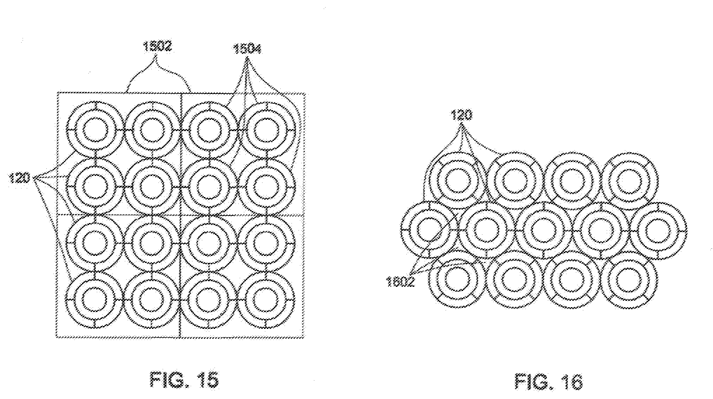

FIGS. 15-18 illustrates different schematic representations of arrangement of the array of coils 120 of the FOD sub-system 116, in accordance with embodiments of the present invention. In the embodiment of FIG. 15, the coils 120 are arranged in a square pattern. Further, the coils 120 may be parallelly or serially coupled to the injection unit 122 (shown in FIG. 1). In one embodiment, the coils 120 may be arranged to form subsets 1502 of coils 120, where each subset 1502 has a predetermined number of coils 120. In one example, four adjacent coils 1504 are coupled in parallel or series to each other to form one subset 1502 of coils 120. In the embodiment of FIG. 16, the coils 120 are arranged in a hexagonal pattern to reduce or minimize gap or empty space 1602 between the coils 120, which in-turn improves the sensitivity of detection of the foreign object. Further, the coils 120 may be parallelly or serially coupled to the injection unit. It may be noted that the coils 120 may be arranged in any desired pattern, and is not limited to patterns shown in FIGS. 15 and 16. Also, in one embodiment, the coils 120 may be formed on a PCB board. Moreover, the coils 120 may be of any shape, such as circular, rectangle, triangle, helical, and oval. It may be noted that the coils may be of any desired shape and size, and is not limited to the shape and size shown in FIGS. 15 and 16.

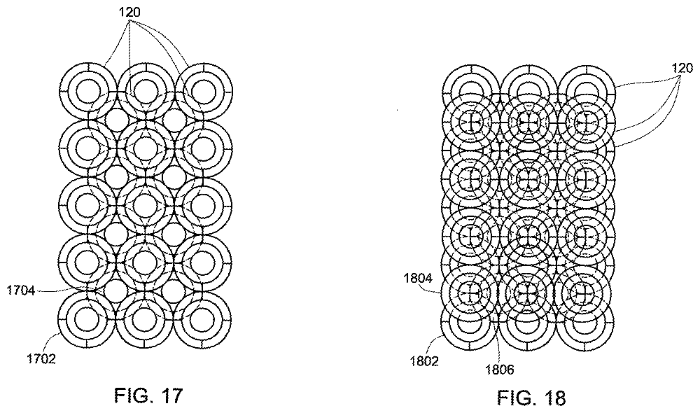

Furthermore, in the embodiment of FIG. 17, the coils 120 are arranged in two layers, such as a first layer 1702 and a second layer 1704. Also, each layer 1702, 1704 may include the coils 120 arranged in one or more patterns, such as the square pattern or the hexagonal pattern. In the embodiment of FIG. 17, the coils 120 are arranged in the square pattern. Further, the first and second layers 1702, 1704 are displaced from one another so that the coils 120 in the second layer 1704 are positioned below the gap between the coils 120 in the first layer 1702. Such a displaced arrangement of the layers 1702, 1704 of the coils enables to minimize gaps between the coils 120, which in-turn improves the sensitivity of detection of the foreign object. The embodiment of FIG. 18 is similar to the embodiment of FIG. 17, except that three layers 1802, 1804, 1806 of the coils 120 are shown displaced from one another to further improve the sensitivity of detection of the foreign object.

The method and systems described hereinabove aid in detecting one or more foreign objects in the wireless power transfer system. Also, the foreign object is detected using low power signals and without affecting main power transfer in the wireless power transfer system. Moreover, the method and systems described hereinabove ensure that the wireless power transfer system is compliant to society of automotive engineers (SAE) standards. Further, the coils may be printed on a PCB board, which enables a simple and a low-cost implementation of the FOD system.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

I/We claim:

1. A device for detecting a foreign object (112) in a wireless power transfer system (100), the device comprising:
an injection unit (122) configured to receive a direct current (DC) power signal and generate a first alternating current (AC) power signal having a first frequency based on the received DC power signal;
an array of coils (120) operatively coupled to the injection unit (122) and configured to receive the first AC power signal having the first frequency and generate a first electromagnetic field at the first frequency; and
a detection unit (124) operatively coupled to the array of coils (120) and configured to:
measure a parameter of at least one of the DC power signal received by the injection unit (122) and the first AC power signal generated by the injection unit (122); and
detect the foreign object (112) within the first electromagnetic field based on a change in the parameter of at least one of the DC power signal and the first AC power signal across at least one of the array of coils (120).

2. The device of claim 1, wherein the parameter of the DC power signal comprises at least one of current, a voltage, and power of the DC power signal, and wherein the parameter of the first AC power signal comprises at least one of current, a voltage, power, and a phase angle between the voltage and the current of the first AC power signal.

3. The device of claim 1, wherein the detection unit (124) comprises a sensing sub-unit (302) electrically coupled to the injection unit (122) and configured to measure the parameter of at least one of the DC power signal and the first AC power signal.

4. The device of claim 3, wherein the detection unit (124) further comprises a processor (304) electrically coupled to the sensing sub-unit (302) and configured to:
compare the measured parameter to a predefined value to determine the change in the parameter of at least one of the DC power signal and the first AC power signal;
detect the foreign object (112) if the change in the parameter of at least one of the DC power signal and the first AC power signal is greater than a threshold value; and
generate a control signal if the foreign object (112) is detected.

5. The device of claim 4, wherein the detection unit (124) further comprises a communication sub-unit (308) operatively coupled to the processor (304) and configured to transmit the generated control signal to a power transmission sub-system (108) of the wireless power transfer system (100) in order to cease transmission of a second AC power signal having a second frequency to a power reception sub-system (110), and wherein power of the second AC power signal is greater than power of the first AC power signal.

6. The device of claim 5, wherein the array of coils (120) is positioned within a second electromagnetic field corresponding to the second AC power signal generated by the power transmission sub-system (108).

7. The device of claim 1, wherein coils in the array of coils (120) are arranged to form at least one of a square pattern, a hexagonal pattern, one or more layered structures, and wherein coils are coupled to one another in series, parallel, or a combination thereof.

8. The device of claim 1, wherein each of the array of coils (120) is individually coupled to the injection unit (122).

9. The device of claim 8, further comprising a plurality of switches (706), wherein each of the switches (706) is coupled to the injection unit (122) and a corresponding coil of the array of coils (120).

10. The device of claim 9, wherein the detection unit (124) is electrically coupled to the plurality of switches (706) and configured to activate each of the switches (706) to transmit the first AC power signal from the injection unit (122) to the corresponding coil of the array of coils (120).

11. The device of claim 10, wherein the detection unit (124) is configured to select and drive one or more coils of the array of coils (120, 702) for transmitting the first AC power signal by activating a corresponding switch of the plurality of switches (706), and wherein the one or more coils are selected to concurrently generate the first electromagnetic field corresponding to the first AC power signal.

12. The device of claim 10, wherein the detection unit (124) is configured to activate each of the switches (706) in a predefined order to select and drive a corresponding coil of the array of coils (120, 702) in a cyclic manner.

13. A method for detecting a foreign object (112) in a wireless power transfer system (100), the method comprising:
receiving, by an injection unit (122), a direct current (DC) power signal;
generating, by the injection unit (122), a first AC power signal having a first frequency based on the DC power signal;
generating, by an array of coils (120) operatively coupled to the injection unit (122), a first electromagnetic field at the first frequency; and
measuring, by a detection unit (124), a parameter of at least one of the DC power signal received by the injection unit (122) and the first AC power signal generated by the injection unit (122); and
detecting, by the detection unit (124), the foreign object (112) within the first electromagnetic field of the wireless power transfer system (100) based on a change in the parameter of at least one of the DC power signal and the first AC power signal across at least one of the array of coils (120).

14. The method of claim 13, wherein the parameter of the DC power signal comprises at least one of current, a voltage, and power of the first power signal, and wherein the parameter of the first AC power signal comprises at least one of current, a voltage, power, and a phase angle between the voltage and the current of the first AC power signal.

15. The method of claim 13, wherein detecting the foreign object (112) comprises:
measuring, by a sensing sub-unit (302) of the detection unit (124), the parameter of at least one of the DC power signal and the first AC power signal;
comparing, by a processor (304) of the detection unit (124), the measured parameter to a predefined value to determine the change in the parameter of at least one of the DC power signal and the first AC power signal;
detecting, by the processor (304), the foreign object (112) if the change in the parameter of at least one of the DC power signal and the first AC power signal is greater than a threshold value; and
generating a control signal if the foreign object (112) is detected.

16. The method of claim 14, further comprising transmitting, by a communication sub-unit (308) of the detection unit (124), the generated control signal from the processor (304) to a power transmission sub-system (108) of the wireless power transfer system (100) in order to cease transmission of a second AC power signal having a second frequency to a power reception sub-system (110), and wherein power of the second AC power signal is greater than power of the first AC power signal.

17. The method of claim 16, further comprising transmitting, by a plurality of switches (706), the first AC power signal from the injection unit (122) to a corresponding coil of the array of coils (120).

18. The method of claim 17, further comprising selecting and driving, by the detection unit (124), one or more coils of the array of coils (120) for transmitting the first AC power signal by activating a corresponding switch of the plurality of switches (706), and wherein the one or more coils are selected to concurrently transmit the first AC power signal.

19. A wireless power transfer system (100) comprising:
a foreign object (112) detection sub-system comprising:
an injection unit (122) configured to receive a direct current (DC) power signal and generate a first alternating current (AC) power signal having a first frequency based on the received DC power signal; and
an array of coils (120) operatively coupled to the injection unit (122) and configured to receive the first AC power signal having the first frequency and generate a first electromagnetic field at the first frequency;
a detection unit (124) operatively coupled to the array of coils (120) and configured to:
measure a parameter of at least one of the DC power signal received by the injection unit (122) and the first AC power signal generated by the injection unit (122); and
detect a foreign object (112) within the first electromagnetic field of the wireless power transfer system based on a change in the parameter of at least one of the DC power signal and the first AC power signal across at least one of the array of coils (120); and
a power transmission sub-system (108) comprising:
a power drive unit (202) configured to generate a second AC power signal having a second frequency, wherein power of the second AC power signal is greater than power of the first AC power signal;
a primary coil (206) operatively coupled to the power drive unit (202) and configured to transmit the second AC power signal having the second frequency to a power reception sub-system (110), wherein the primary coil (206) generates a second electromagnetic field at the second frequency; and
a control unit (204) operatively coupled to the power drive unit (202) and configured to send a termination signal to the power drive unit (202) in order to cease the transmission of the second AC power signal if the foreign object (112) is detected.

20. The wireless power transfer system (100) of claim 19, wherein the detection unit (124) comprises a sensing sub-unit (302) electrically coupled to the injection unit (122) and configured to measure the parameter of at least one of the DC power signal and the first AC power signal.

21. The wireless power transfer system (100) of claim 20, wherein the detection unit (124) further comprises a processor (304) electrically coupled to the sensing sub-unit (302) and configured to:
compare the measured parameter to a predefined value (baseline value) to determine the change in the parameter of at least one of the DC power signal and the first AC power signal;
detect the foreign object (112) if the change in the parameter of at least one of the DC power signal and the first AC power signal is greater than a threshold value; and
generate a control signal if the foreign object (112) is detected.

22. The wireless power transfer system (100) of claim 21, wherein the processor (304) is further configured to transmit the control signal to the control unit in order to cease transmission of the second AC power signal having the second frequency if the foreign object (112) is detected.

23. The wireless power transfer system (100) of claim 19, wherein the foreign object (112) detection sub-system comprises a mat (1000) substantially enclosing at least the injection unit (122) and the array of coils (120), and wherein the mat (1000) is detachably coupled to the power transmission sub-system.

24. The wireless power transfer system (100) of claim 23, wherein the mat (1000) comprises a thermally conductive and electrically insulating material, and wherein the mat comprises at least one of a flexible material and a hard material.

25. The wireless power transfer system (100) of claim 23, wherein the mat (1000) is configured to conform to a shape corresponding to a position of the power transmission sub-system (108).
